(19) United States
(12) Patent Application Publication
(10) Pub. No.: US 2005/0265301 A1
(43) Pub. Date: Dec. 1, 2005

(54) Method of transmitting scheduling information on an enhanced uplink dedicated channel in a mobile communication system

(75) Inventors: Youn-Hyoung Heo, Suwon-si (KR); Sung-Ho Choi, Suwon-si (KR); Ju-Ho Lee, Suwon-si (KR); Yong-Jun Kwak, Yongin-si (KR); Kyeong-In Jeong, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/057,894

(22) Filed: Feb. 14, 2005

(30) Foreign Application Priority Data
Feb. 14, 2004 (KR) 2004-9876

(51) Int. Cl. H04J 3/24

(52) U.S. Cl. 370/349

(57) ABSTRACT

An apparatus and method of transmitting scheduling information from a UE to a Node B to request Node B controlled scheduling in an asynchronous CDMA communication system supporting an E-DCH packet data service is provided. The UE generates a MAC-e PDU including only scheduling information representing a buffer status and a power status in relation to uplink data transmission, and transmits the MAC-e PDU on an E-DCH along with TF information indicating the transmission of the MAC-e PDU including the scheduling information. The Node B receives the scheduling information on the E-DCH and schedules uplink data transmission according to the scheduling information.

### PRIORITY

This application claims priority under 35 U.S.C. § 119 to an application entitled “Method of Transmitting Scheduling Information on Enhanced Uplink Dedicated Channel in a Mobile Communication System” filed in the Korean Intellectual Property Office on Feb. 14, 2004 and assigned Serial No. 2004-9876, the contents of which are incorporated herein by reference.

### BACKGROUND OF THE INVENTION

1. Field of the Invention

The present invention relates generally to a WCDMA (Wideband Code Division Multiple Access) communication system, and in particular, to a method of transmitting scheduling information for requesting an uplink packet data service.

2. Description of the Related Art

The 3^{rd} generation mobile communication system, UMTS (Universal Mobile Telecommunication Service) is based on the GSM (Global System for Mobile communication) and GPRS (General Packet Radio Services) standards and uses WCDMA technology. The UMTS system provides a uniform service that transmits packetized text, digital voice and video, and multimedia data at a 2 Mbps or higher rate to mobile subscribers or computer users around the world. With the introduction of the concept of virtual access, UMTS enables access to any end point in a network. For example, the virtual access refers to packet-switched access using a packet protocol like IP (Internet Protocol).

The UMTS system uses an EUDCH (Enhanced Uplink Dedicated Channel) or E-DCH (Enhanced Dedicated Channel) to improve packet transmission performance on the uplink directed from a UE (User Equipment) to a Node B. To provide stable high-speed data transmission, the E-DCH supports AMC (Adaptive Modulation and Coding), HARQ (Hybrid Automatic Retransmission Request), and Node B controlled scheduling.

A Node B receives scheduling information, e.g., information about buffer status or power status from UEs, for efficient scheduling of uplink data transmission from the UEs. According to the scheduling information, the Node B allocates a low data rate to a UE in a bad channel condition or having data to be serviced with a low priority level, whereas it allocates a high data rate to a UE in a good channel condition or having data to be serviced with a high priority level. As a result, the whole system performance is improved.

One technique for transmitting scheduling information needed for Node B controlled scheduling from UEs is physical layer signaling. The physical layer signaling refers to signaling on a physical channel such as a DPCCH (Dedicated Physical Control Channel) or an HS-DPCCH (High Speed DPCCH). The physical layer, not its higher layer, produces necessary control information and transmits it to the Node B and the physical layer in the Node B demodulates the control information in the UEs.

For the physical layer signaling, a new code channel and a new physical layer format must be determined. However, adding the new code channel is likely to increase PAPR (Peak to Average Power Ratio) and adding the new physical layer format increases complexity in a UE's transmitter or a Node B's receiver.

To increase the efficiency of the Node B controlled scheduling, the UEs can feed back detailed information about buffer status and/or power status, or report different buffer statuses according to service types to the Node B. In this case, a variable data size is required, which makes it difficult to support efficient transmission of the scheduling information by the physical layer signaling with a limited slot format.

### SUMMARY OF THE INVENTION

An object of the present invention is to substantially solve at least the above problems and/or disadvantages and to provide at least the advantages below. Accordingly, an object of the present invention is to provide a method of reliably transmitting scheduling information for controlling uplink packet transmission on an E-DCH.

Another object of the present invention is to provide a method of transmitting and receiving scheduling information on an E-DCH between a Node B and a UE.

A further object of the present invention is to provide a method of transmitting an indicator indicating transmission of a protocol data unit (PDU) including only scheduling information on an E-DCH.

The above and other objects are achieved by providing a method of transmitting scheduling information from a UE to a Node B to request Node B controlled scheduling in an asynchronous CDMA communication system supporting an E-DCH packet data service.

According to one aspect of the present invention, in a method of transmitting scheduling information to request Node B scheduling in a UE in a mobile communication system supporting an enhanced uplink packet data service, the UE generates a MAC-e control PDU including scheduling information representing a buffer status or a power status in relation to uplink data transmission, transmits the MAC-e control PDU on a first E-DCH different from a second E-DCH for transmitting a MAC-e data PDU including uplink packet data.

According to another aspect of the present invention, in a method of transmitting scheduling information to request Node B scheduling in a UE in a mobile communication system supporting an enhanced uplink packet data service, the UE generates scheduling information representing a buffer status or a power status in relation to uplink data transmission, transmits the scheduling information on an E-DCH for a TTI for which uplink packet data is not transmitted, and transmits an indicator indicating the transmission of the scheduling information on a control channel other than the E-DCH.

### BRIEF DESCRIPTION OF THE DRAWINGS

The above and other objects, features, and advantages of the present invention will become more apparent from the following detailed description when taken in conjunction with the accompanying drawings in which:

FIG. 1 is a conceptual view illustrating data transmission via an E-DCH on a conventional radio link;

FIG. 2 is a diagram illustrating a message flow for a conventional E-DCH service procedure;

FIG. 3 illustrates E-DCH transmission according to an embodiment of the present invention;

FIG. 4 is a flowchart illustrating a UE operation according to an embodiment of the present invention;

FIG. 5 illustrates control packet data including buffer status information to be transmitted on the E-DCH;

FIG. 6 is a block diagram of a UE transmitter according to an embodiment of the present invention;

FIG. 7 is a block diagram of a Node B receiver according to an embodiment of the present invention;

FIG. 8 illustrates E-DCH transmission according to an embodiment of the present invention;

FIG. 9 is a block diagram of a UE transmitter according to an embodiment of the present invention;

FIG. 10 is a block diagram of a Node B receiver according to an embodiment of the present invention; and

FIG. 11 is a flowchart illustrating a UE operation according to an embodiment of the present invention.

### DETAILED DESCRIPTION OF THE PREFERRED EMBODIMENTS

Preferred embodiments of the present invention will be described in detail herein below with reference to the accompanying drawings. In the following description, well-known functions or constructions are not described in detail since they would obscure the invention in unnecessary detail.

The present invention as described below pertains to the utilization of an E-DCH in a WCDMA communication system. The E-DCH characteristically supports HARQ, AMC, and Node B controlled scheduling.

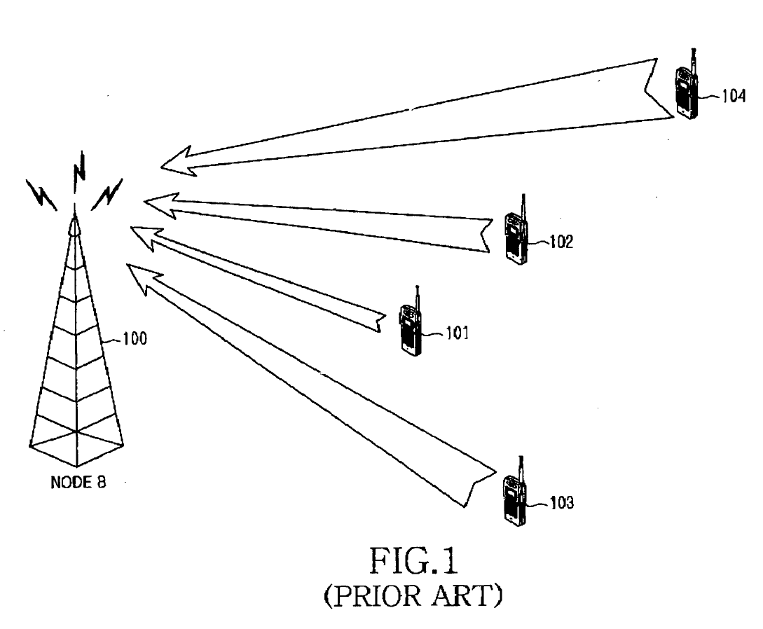

FIG. 1 conceptually illustrates data transmission via the E-DCH on a radio link. Referring to FIG. 1, reference numeral 100 denotes a Node B supporting the E-DCH and reference numerals 101 to 104 denote UEs that transmit the E-DCH. The Node B 100 monitors the channel statuses of the UEs 101 to 104 using the E-DCH and schedules data transmission for the individual UEs 101 to 104. The scheduling is performed in the manner that increases the entire system performance by allocating a low data rate to a remote UE (e.g. the UE 103 or 104) and a high rate to a nearby UE (e.g. the UE 101 or 102), while keeping a noise rise measurement of the Node B 100 at or below a target noise rise.

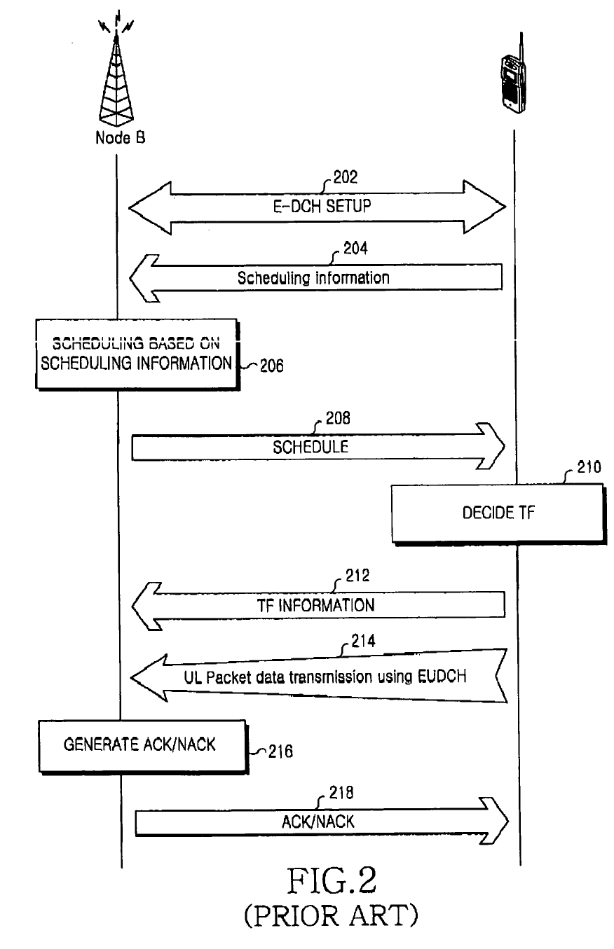

FIG. 2 is a diagram illustrating a message flow for E-DCH transmission and reception. Referring to FIG. 2, a Node B and a UE establish the E-DCH in step 202. This step involves exchanging messages on dedicated transport channels. After the E-DCH setup, the UE reports scheduling information to the Node B in step 204. The scheduling information is uplink channel information, i.e., the transmit power and power margin of the UE and the amount of buffered data to transmit to the Node B.

Upon receiving scheduling information from a plurality of UEs in communications with the Node B, the Node B schedules data transmission for the individual UEs based on the scheduling information in step 206. In step 208, the Node B enables the UE uplink packet transmission and transmits scheduling assignment information to the UE. The scheduling assignment information may indicate an allowed data rate and an allowed timing.

The UE determines the TF (Transport Format) of the E-DCH based on the scheduling assignment information in step 210, transmits the TF information to the Node B in step 212, and transmits uplink packet data to the Node B on the E-DCH in step 214.

The Node B determines if the packet data has errors using the TF information in step 216. Upon detecting errors in the packet data, the Node B transmits a NACK (Non-Acknowledgement) signal to the UE, whereas in the absence of errors in the packet data, the Node B transmits an ACK (Acknowledgement) signal to the UE in step 218. Upon receiving the NACK signal, the UE retransmits packet data having the same information and upon receiving the ACK signal, it transmits new data because the previous packet data transmission is completed. If the UE does not receive either the ACK or the NACK signal, it transmits MISS information to the Node B.

A Uu interface is defined between a UE and a UTRAN (UMTS Terrestrial Radio Access Network). The Uu interface is divided into a control plane (C-plane) for exchanging control signals between the UE and the UTRAN and a user plane (U-plane) for transmitting actual data.

An RRC (Radio Resource Control) layer, an RLC (Radio Link Control) layer, a MAC (Medium Access Control) layer, and a PHY (PHYsical) layer exist on the C-plane. On the U-plane, there exist a PDCP (Packet Data Control Protocol) layer, a BMC (Broadcast/Multicast Control) layer, the RLC layer, the MAC layer, and the PHY layer. The PHY layer is defined in each Node B or cell, and the MAC layer through the RRC layer is defined in each RNC.

The PHY layer provides an information delivery service by a radio transfer technology, and corresponds to layer 1 (L1) in an OSI (Open Systems Interconnection) model. The PHY layer is connected to the MAC layer via transport channels. The mapping relationship between the transport channels and physical channels is determined according to how data is processed in the PHY layer. A TF describes how data is transmitted on a transport channel, whereas a TFCI (TFC Indicator) indicating one of TFCs (Transport Format Combinations) describes how data is transmitted on a physical channel onto which a plurality of transport channels are mapped.

The MAC layer is connected to the RLC layer via logical channels. The MAC layer delivers data received from the RLC layer to the PHY layer on appropriate transport channels, and also delivers data received from the PHY layer on transport channels to the RLC layer on appropriate logical channels. The MAC layer inserts additional information into data received on logical channels or transport channels or performs an appropriate operation by interpreting inserted additional information, and controls random access. A U-plane-related part is a MAC-d entity and a C-plane-related part is a MAC-c entity in the MAC layer.

The RLC layer is responsible for establishing and releasing the logical channels. The RLC layer operates in one of an acknowledged mode (AM), an unacknowledged mode (UM), and a transparent mode (TM), and provides different functionalities in those modes. Typically, the RLC layer segments or concatenates SDUs (Service Data Units) received from an upper layer to an appropriate size and corrects errors by ARQ.

The PDCP layer is above the RLC layer on the U-plane. The PDCP layer compresses and decompresses the header of data taking the form of an IP packet and performs lossless data delivery under the situation that an RNC for providing service to a particular UE is changed due to the UE's mobility.

The configuration of a transport channel for connecting the PHY layer to the upper layers is determined by the TF, which defines processes including convolutional channel encoding, interleaving, and service-specific rate matching.

In the UE, the MAC-e entity generates a MAC-e control PDU including scheduling information and transmits it on the E-DCH. The MAC-e entity of the Node B reads the scheduling information for use in a scheduler. The MAC-e control PDU includes the scheduling information, with no packet data associated with the E-DCH included. Because the E_DCH supports HARQ, if the UE receives an NACK signal or fails to receive an ACK signal due to errors in the transmission of the MAC-e control PDU, it retransmits the MAC-e PDU. The retransmitted scheduling information has values measured at a retransmission time point.

Four embodiments of the present invention are provided in relation to transmission of a MAC-e control PDU on the E-DCH. The first two embodiments are directed to transmission of the MAC-e control PDU on an E-DCH other than the E-DCH that delivers packet data, and the last two embodiments are directed to transmission of the MAC-e control PDU on the E-DCH that delivers packet data.

### First Embodiment

Uplink data is transmitted on the conventional E-DCH for a PHY layer transmission period, TTI (Transmission Time Interval) and, at the same time, a MAC-e control PDU including scheduling information is transmitted on another E-DCH.

The MAC-e entity of the UE reports to the Node B the amount of buffered data as scheduling information. The Node B then allocates a maximum data rate to the UE based on the scheduling information. The UE transmits packet data at or below the allocated maximum data rate, or at a minimum data rate when no data rate is allocated to the UE. Thereafter, the UE transmits scheduling information according to a predetermined rule.

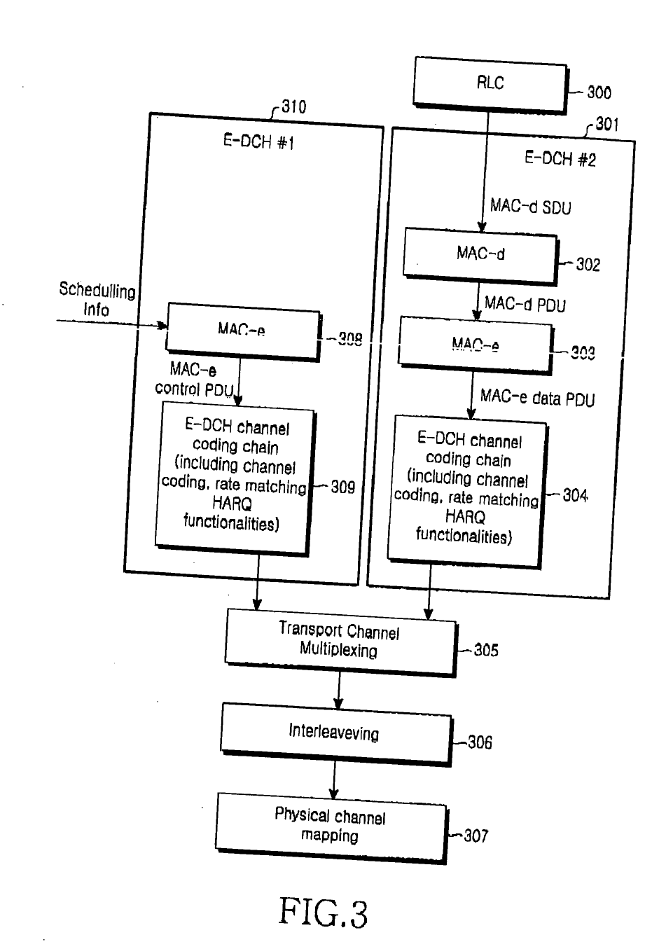

FIG. 3 illustrates E-DCH transmission according to an embodiment of the present invention. The E-DCH transmission operation includes a procedure 301 for transmitting data on a second E-DCH (E-DCH #2) and a procedure 310 for transmitting scheduling information on a first E-DCH (E-DCH #1).

Referring to FIG. 3, in the E-DCH #2 transmission procedure 301, transmission data generated from the RLC entity controlling the RLC layer is converted to a MAC-d PDU in step 302 (MAC-d generation) and converted to a MAC-e PDU for transmission on E-DCH #2 in step 303 (MAC-e generation). The MAC-e PDU is processed in an E-DCH coding chain through encoding, rate-matching, and an HARQ operation in step 304.

Regarding the operation of the UE for packet data transmission, upon generation of packet data for a particular service, a MAC-d SDU including the packet data is generated in step 300 (RLC generation). The MAC-d SDU is converted to a MAC-d PDU in step 302. The MAC-d PDU is buffered according to a priority level corresponding to the type of the service and converted to a MAC-e PDU according to a TF selected from a TFS (Transport Format Set) at or below a maximum data rate allocated from the Node B in step 303.

A MAC-e control PDU including scheduling information is transmitted on E-DCH #1. Accordingly, the E-DCH #1 transmission procedure 310 does not include the MAC-d generation step 302 and the MAC-e control PDU is generated out of the scheduling information in step 308 (MAC-e generation). The MAC-e control PDU is processed in an E-DCH channel coding chain through encoding, rate-matching and an HARQ operation in step 309.

The coded data produced by the E-DCH transmission procedures 301 and 310 are multiplexed in step 305 (Tr CH multiplexing), interleaved in step 306, and mapped onto an E-DPDCH (Enhanced Dedicated Physical Data Channel) and then transmitted in step 307.

Examples of TFSs and TFCs that enable simultaneous transmission of packet data and scheduling information for one TTI in the above-described channel structure are given in Table 1.

TABLE 1

| | |
|---|---|
| TFS for E-DCH #1 | TF0, TF1 |
| TFS for E-DCH #2 | TF0, TF1, TF2 |
| (E-TFC) | (E-DCH #1, E-DCH #2) = 1(TF0, TF0), 2(TF0, |
| | TF1), 3(TF0, TF2), 4(TF1, TF0), 5(TF1, TF1), |
| | 6(TF1, TF2) |

TFS refers to a set of available TFs and TFC refers to a combination of TFCs to be allocated to transport channels. E-TFC is indicated by an E-TFCI ranging from 1 to 6. TF0 indicates that no transmission data exists on a corresponding E-DCH. E-TFCI 4 implies that only E-DCH #1 is transmitted, and E-TFCI 5 and E-TFCI 6 indicate that both E-DCH #1 and E-DCH #2 are transmitted.

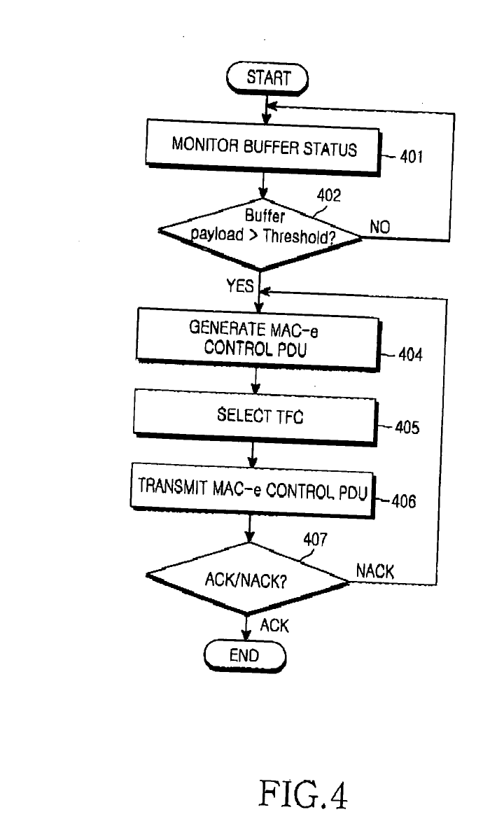

FIG. 4 is a flowchart illustrating a UE operation according to an embodiment of the present invention. Referring to FIG. 4, the UE monitors the status of a buffer for storing packet data to be transmitted to the Node B in step 401 and compares the payload of the buffer with a predetermined threshold in step 402. If the payload size exceeds the threshold, the UE generates a MAC-e control PDU using the buffer status information and power status information to transmit scheduling information in step 404. The buffer status information is reflected in the scheduling information when the amount of buffered data exceeds the threshold, or periodically.

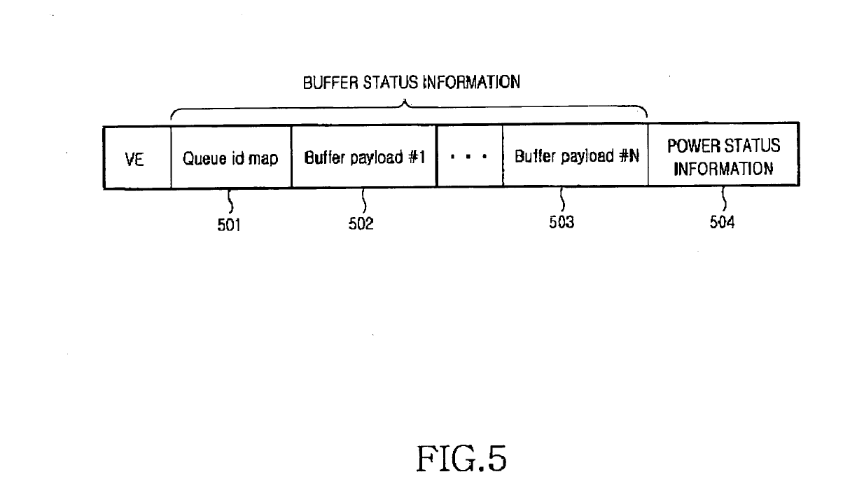

An exemplary structure of the MAC-e control PDU is illustrated in FIG. 5. Referring to FIG. 5, the MAC-e control PDU includes a Queue ID Map 501 indicating the buffer status, Buffer Payloads 502 to 503, and Power Status Info 504. The Buffer Payloads 502 to 503 indicate buffer payload sizes for a plurality of services having different priority levels.

Returning to FIG. 4, the UE selects a TFC for the MAC-e control PDU in step 405. If there exists packet data now to be transmitted, the UE selects an E-TFC that enables data transmission on the two E-DCHs for one TTI referring to Table 1. In Table 1, either E-TFCI 5 or E-TFCI 6 can serve for this case. In the absence of transmission packet data, E-TFCI 4 is selected.

In step 406, the UE transmits the MAC-e control PDU on E-DCH #1 and a MAC-e PDU including packet data on E-DCH #2 according to the selected E-TFC. Simultaneously, an E-TFCI indicating the selected E-TFC is delivered to the Node B on an E-DPCCH (Dedicated Physical Control Channel for E-DCH). The UE then awaits receipt of an ACK/NACK signal for the MAC-e control PDU from the Node B in step 407. If the UE receives the NACK signal or fails to receive the ACK signal, it returns to step 404 to retransmit the MAC-e control PDU. The reason for returning to step 404 is to estimate the buffer status and/or the power status without retransmitting the initial MAC-e control PDU at the time retransmission is because the scheduling information may vary over time. However, it is obvious that the initial MAC-e control PDU can be retransmitted without any change, for implementation simplicity.

Meanwhile, considering that the ACK/NACK signal is transmitted generally with high reliability, the UE may omit step 407 or determine whether to retransmit the MAC-e control PDU by determining the reliability of the MAC-e control PDU transmission based on an ACK/NACK signal received for packet data.

Detection of an E-TFCI precedes receipt of E-DCH signals from the UE in the Node B. If the E-TFCI is E-TFCI 4, E-TFCI 5, or E-TFCI 6, the Node B determines that the UE has transmitted the scheduling information, acquires the scheduling information in a MAC-e control PDU by demodulating E-DCH #1, and uses it along with scheduling information received from other UEs in scheduling uplink data transmission. When ACK/NACK channels are established for the two E-DCHs in the UE, the Node B transmits ACK/NACK signals to the UE on the ACK/NACK channels based on an error check of the MAC-e control PDU.

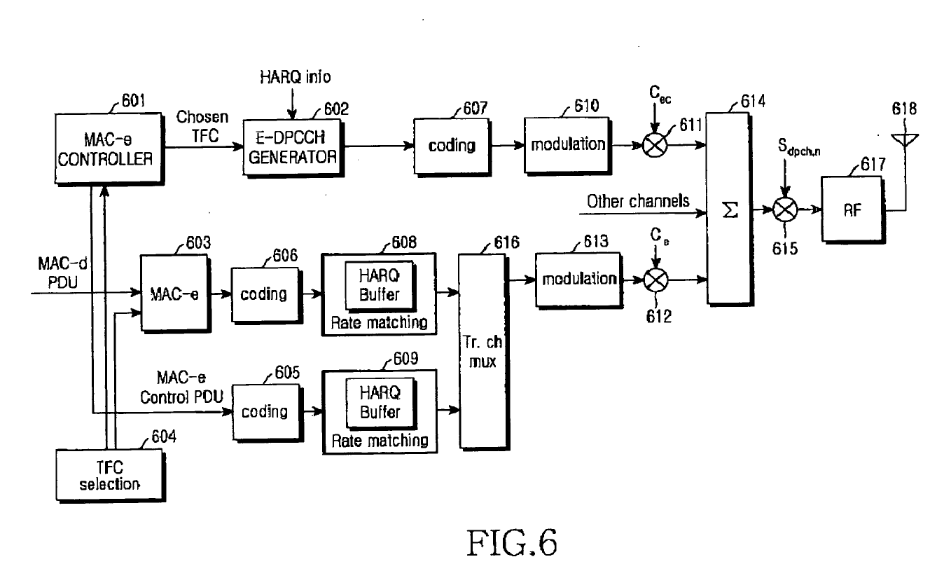

FIG. 6 is a block diagram of a UE transmitter according to an embodiment of the present invention. Referring to FIG. 6, a TFC selector 604 selects TFCs for E-DCH #1 and E-DCH #2, for example, TFCI 5=(TF1, TF1) or TFCI 6=(TF1, TF2), and provides the selected TFCs to a MAC-e controller 601 and a MAC-e generator 603.

The MAC-e controller 601 monitors buffer status and/or power status associated with uplink data transmission and generates a MAC-e control PDU including scheduling information indicating the buffer status and/or the power status. The MAC-e control PDU is encoded in an encoder 605 and rate-matched in a rate matcher 609 with an HARQ buffer, for transmission on E-DCH #1. The MAC-e generator 603 converts a MAC-d PDU including packet data to a MAC-e data PDU. The MAC-e data PDU is encoded in an encoder 606 and rate-matched in a rate matcher 608 with an HARQ buffer.

A transport channel multiplexer (Tr CH MUX) 616 multiplexes the rate-matched MAC-e control PDU and MAC-e data PDU. The multiplexed data is modulated in a modulator 613, spread with a spreading code Cₑ allocated to the E-DCHs in a spreader 612, and provided to a channel summer 614.

An E-DPCCH generator 602 generates an E-DPCCH frame including a TFCI indicating the selected TFCs according to HARQ information. The E-DPCCH frame is encoded in an encoder 607, modulated in a modulator 610, spread with a spreading code C_{ec} allocated to the E-DPCCH in a spreader 611, and provided to the channel summer 614.

The channel summer 614 sums the E-DCHs, the E-DPCCH, and other spread channel data. The summed data is scrambled with a scrambling code S_{dpch,n} in a scrambler 615, loaded onto an RF (Radio Frequency) signal in an RF module 617, and then transmitted to the Node B through an antenna 618.

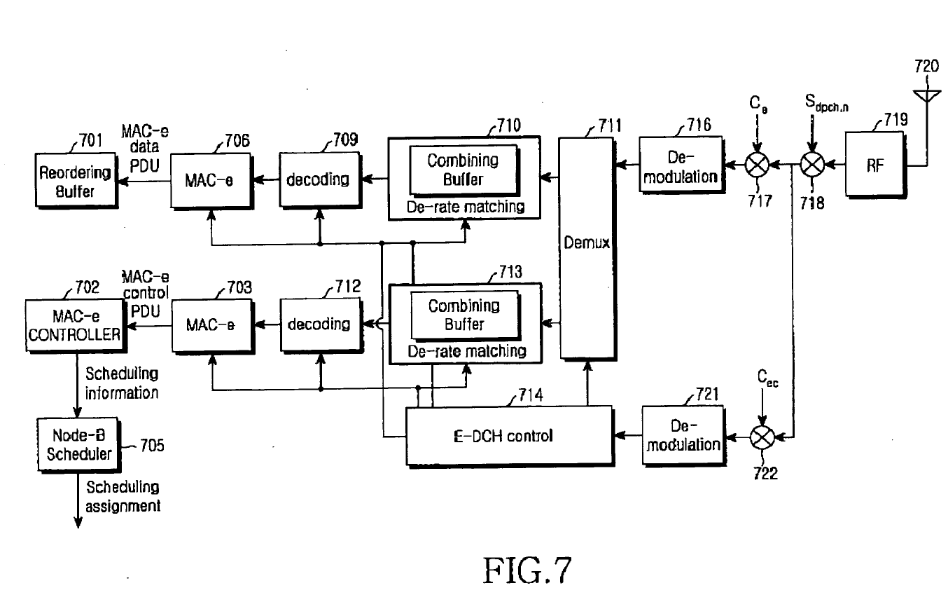

FIG. 7 is a block diagram of a Node B receiver according to an embodiment of the present invention. The illustrated demodulation configuration is similar to that for a multiplexed DCH.

Referring to FIG. 7, an RF module 719 converts signals, which are received from a plurality of UEs within the cell area of the Node B through an antenna 720, to a baseband signal. A descrambler 718 descrambles the baseband signal with the scrambling code S_{dpch,n} allocated to the UE. A despreader 717 despreads the descrambled DPCH signal with the spreading code Cₑ allocated to the E-DCHs in order to detect the E-DCH signals from the DPCH signal. The E-DCH signals are demodulated in a demodulator 716 and demultiplexed in a demultiplexer (DEMUX) 711.

A despreader 722 despreads the descrambled DPCH signal with the spreading code C_{ec} allocated to the E-DPCCH in order to detect the E-DPCCH signal from the DPCH signal. A demodulator 721 demodulates the E-DPCCH signal and an E-DCH controller 714 detects control information to demodulate the E-DCH, i.e., TF information from the demodulated data.

The DEMUX 711 demultiplexes the signal demodulated by the demodulator 716 into a plurality of E-DCH or DCH signals and provides an E-DCH #1 signal and an E_DCH #2 signal to rate dematchers 713 and 710, each having a combining buffer. The E-DCH #2 signal is provided to a MAC-e detector 706 through the rate dematcher 710 and a decoder 709. Similarly, the E-DCH #1 signal is provided to a MAC-e detector 703 through the rate dematcher 713 and a decoder 712. The MAC-e detectors 706 and 703 detect a MAC-e data PDU and a MAC-e control PDU, respectively.

The MAC-e data PDU of E-DCH #2 is provided to a reordering buffer 701 used for data transmission and reception between the MAC layer and its overlying layer. The MAC-e control PDU of E-DCH #1 is provided to a MAC-e controller 702 because it has scheduling information. The MAC-e controller 702 reads the buffer status and/or power status information from the MAC-e control PDU. A Node B scheduler 705 allocates uplink data rates to individual UEs based on scheduling information from the UE and other UEs. Although not shown, scheduling assignment information indicating the allocated data rates is transmitted to the UEs on the downlink.

### Second Embodiment

While a MAC-e data PDU and a MAC-e control PDU are delivered on different E-DCHs, only one type of E-DCH is allowed for transmission for one TTI. Compared to the first embodiment of the present invention where both the MAC-e data PDU and MAC-e control PDU are transmitted simultaneously, the separate MAC-e PDU transmission eliminates Node B transmit power dissipation and HARQ complexity, which might otherwise be caused by transmission of a plurality of ACK/NACK signals to each UE.

The UE uses different E-DHCs in transmitting PDUs having different attributes, but transmits only one PDU for one TTI rather than simultaneously transmit them. While this embodiment adopts the channel configuration illustrated in FIG. 3, a TFC is selected such that a plurality of E-DCHs are not multiplexed for one TTI.

Exemplary E-TFCs for transmitting one E-DCH for one TTI are given in Table 2 below.

TABLE 2

| | |
|---|---|
| TFS for E-DCH #1 | TF0, TF1 |
| TFS for E-DCH #2 | TF0, TF1, TF2 |
| (E-TFC) | (E-DCH #1, E-DCH #2) = 1(TF0, TF0), 2(TF0, |
| | TF1), 3(TF0, TF2), 4(TF1, TF0) |

E-TFCI 1 indicates transmission of none of the E-DCHs, E-TFCI 2 and E-TFCI 3 indicate transmission of E-DCH #2 only, and E-TFCI 4 indicates transmission of E-DCH #1 only.

The UE determines if there is packet data to be transmitted on E-DCH #2 for each TTI. In the absence of the packet data, or if the packet data exists but has a low priority level at or below a predetermined threshold, the UE decides to transmit scheduling information. The UE also prioritizes scheduling information. If the current packet data is lower than the scheduling information in priority, the UE decides to first transmit the scheduling information. The UE selects a TFC available for transmission of a MAC-e control PDU for a TTI designated for transmission of the scheduling information, TFC4=(TF1, TF0) in Table 2.

In accordance with the second embodiment of the present invention, a Node B transmits ACK/NACK signals normally for E-DCHs transmitted by a UE, without allocating many downlink code channels or much transmit power. Therefore, the transmission reliability of a MAC-e control PDU is increased and an HARQ operation is simplified between the Node B and the UE.

### Third Embodiment

One E-DCH is transmitted for one TTI and transmission of a MAC-e control PDU is notified by a TF used to demodulate the E-DCH. More specifically, the UE transmits an indicator indicating transmission of a MAC-e control PDU including scheduling information. Preferably the indicator is a predetermined TF.

When necessary, the UE transmits a MAC-e control PDU including scheduling information or a MAC-e data PDU including packet data on one E-DCH. In the former case, the UE transmits an indicator indicating the MAC-e control PDU on an additional control channel.

If the indicator indicates that a received MAC-e PDU is a MAC-e control PDU including scheduling information, the Node B provides the MAC-e PDU to a MAC-e controller. If the indicator indicates that the received MAC-e PDU is a MAC-e data PDU, the Node B stores the MAC-e PDU in a reordering buffer so that it can be transmitted to an upper layer. A MAC-e controller reads information about buffer status and/or power status from the MAC-e control PDU and provides the information to a Node B scheduler.

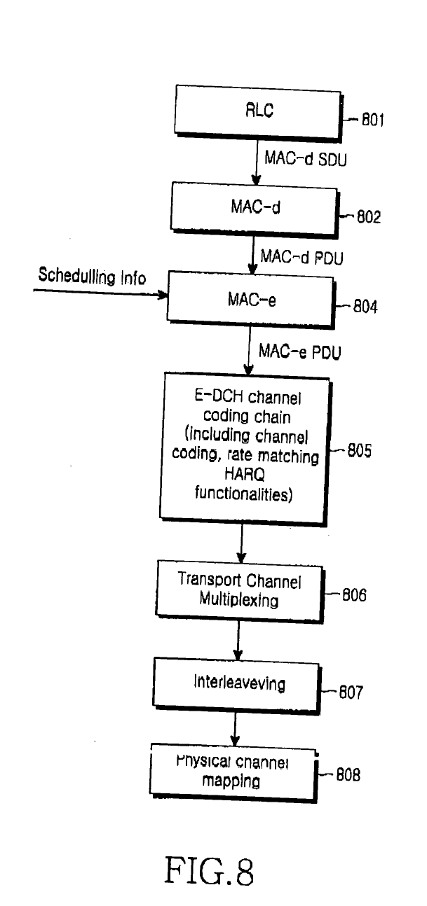

FIG. 8 illustrates E-DCH transmission according to a third embodiment of the present invention. Referring to FIG. 8, a MAC-d SDU including the packet data is generated in step 800 (RLC generation). The MAC-d SDU is converted to a MAC-d PDU in step 802 (MAC-d generation). A MAC-e data PDU is generated out of the MAC-d PDU or a MAC-e control PDU is generated out of scheduling information, for transmission on an E-DCH in step 804 (MAC-e generation). The MAC-e PDU is processed in an E-DCH coding chain through encoding, rate-matching, and a HARQ operation in step 805. The coded data is multiplexed with coded data for other channels in step 806 (Tr CH multiplexing), interleaved in step 807, and mapped to a physical channel in step 808, prior to transmission on the physical channel.

Accordingly, the MAC-e control PDU and the MAC-e data PDU are delivered on the same E-DCH. The thus-configured channel structure enables transmission of one of the packet data and the scheduling information on one E-DCH for one TTI. Exemplary E-TFSs supporting this transmission scheme are as follows.
E-TFS=(TF0), (TF1), (TF2), (TF3), (TF4)

It is assumed herein that one transport block is transmitted on the E-DCH for each TTI.

In the case of the scheduling information, the UE selects a TF (e.g., TF1) among the available TFs, which was preset to indicate that a transmitted MAC-e PDU is a MAC-e control PDU including the scheduling information. The Node B determines by TF1 that the received MAC-e PDU includes the scheduling information.

When the amount of buffered data to be transmitted on the E-DCH is equal to or greater than a predetermined threshold or the power status needs to be reported, the UE selects a TF to transmit the scheduling information. If no packet data exists or the priority level of packet data is lower than that of a MAC-e control PDU, the UE selects a predetermined TF, for example, TF1. The UE then generates the MAC-e control PDU, encodes and rate-matches it like packet data, and transmits the MAC-e control PDU to the Node B. At the same time, the UE notifies the Node B of TF1 via a control channel.

Upon receiving data (MAC-e PDU) on the E-DCH with TF1, the Node B determines that it is a MAC-e control PDU and uses the MAC-e PDU as scheduling information after decoding. The Node B transmits an ACK/NACK signal for the MAC-e control PDU on an ACK/NACK channel to the UE, as for the MAC-e data PDU. Because the MAC-e control PDU is transmitted in the absence of the MAC-e data PDU, the Node B transmits only one ACK/NACK signal.

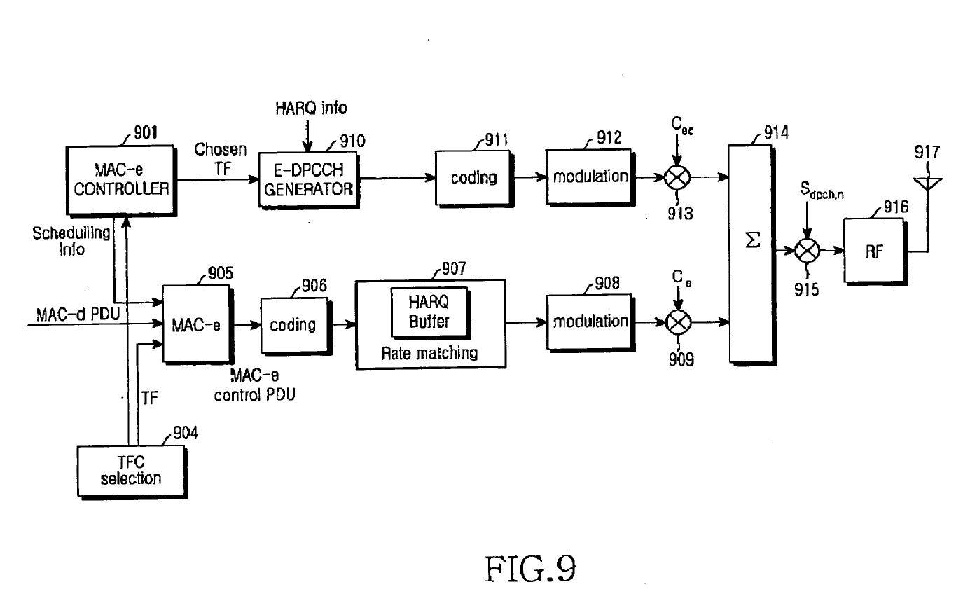

FIG. 9 is a block diagram of a UE transmitter according to an embodiment of the present invention. Referring to FIG. 9, a TFC selector 904 selects an appropriate TF depending on whether packet data or scheduling information is transmitted on the E-DCH and provides the selected TF to a MAC-e controller 901 and a MAC-e generator 905.

If the TF indicates transmission of scheduling information, the MAC-e controller 901 monitors buffer status and/or power status associated with E-DCH data transmission and provides scheduling information representing the buffer status and/or the power status to the MAC-e generator 905. That is, the MAC-e controller 901 generates the scheduling information if the selected TF is a predetermined TF, for example, TF1.

The MAC-e generator 905 receives the scheduling information and generates a MAC-e control PDU including the scheduling information. In the absence of the scheduling information, the MAC-e generator 905 receives a MAC-d PDU including packet data to be transmitted on the E-DCH and generates a MAC-e data PDU including the packet data. The MAC-e PDU is encoded in an encoder 906 and rate-matched in a rate matcher 907 with an HARQ buffer. The rate-matched data is modulated in a modulator 908, spread with a spreading code Cₑ allocated to the E-DCH in a spreader 909, and provided to a channel summer 914.

An E-DPCCH generator 910 generates an E-DPCCH frame including the selected TF, TF1 according to HARQ information. The E-DPCCH frame is encoded in an encoder 911, modulated in a modulator 912, spread with a spreading code C_{ec} allocated to the E-DPCCH in a spreader 913, and provided to the channel summer 914.

The channel summer 914 sums the E-DCH, the E-DPCCH, and other spread channel data. The summed data is scrambled with a scrambling code S_{dpch,n} in a scrambler 915, loaded onto an RF signal in an RF module 916, and then transmitted to the Node B through an antenna 917.

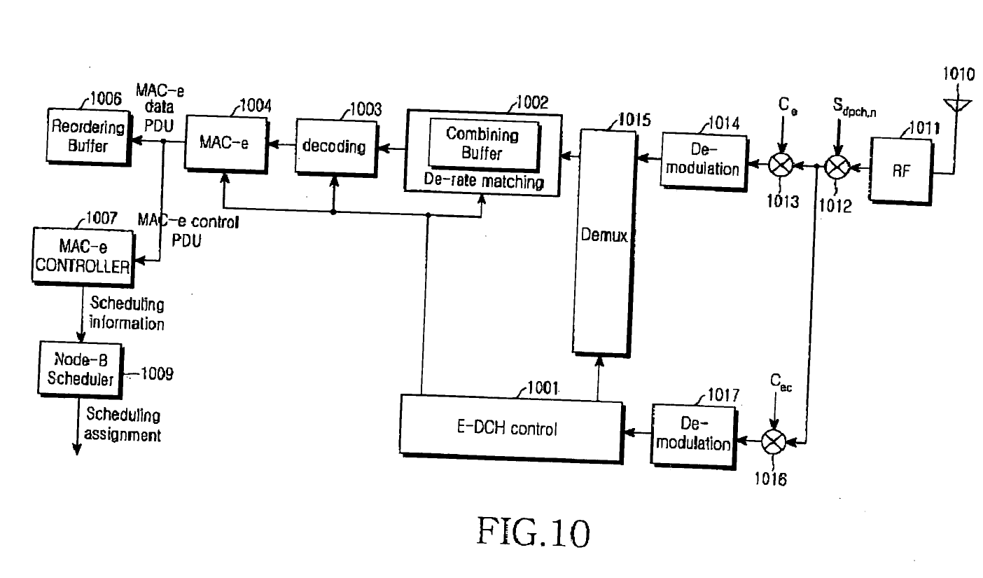

FIG. 10 is a block diagram of a Node B receiver according to an embodiment of the present invention. Referring to FIG. 10, an RF module 1011 converts signals, which are received from a plurality of UEs within the cell area of the Node B through an antenna 1010, to a baseband signal. A descrambler 1012 descrambles the baseband signal with the scrambling code S_{dpch,n} allocated to the UE. A despreader 1013 despreads the descrambled DPCH signal with the spreading code Cₑ allocated to the E-DCH in order to detect the E-DCH signal from the DPCH signal. The E-DCH signal is demodulated in a demodulator 1014 and demultiplexed in a DEMUX 1015.

A despreader 1016 despreads the descrambled DPCH signal with the spreading code C_{ec} allocated to the E-DPCCH in order to detect the E-DPCCH signal from the DPCH signal. A demodulator 1017 demodulates the E-DPCCH signal and an E-DCH controller 1001 detects control information to demodulate the E-DCH, i.e., TF information from the demodulated data.

The DEMUX 1015 demultiplexes the signal demodulated by the demodulator 1014 according to the TF information and provides the resulting E-DCH signal to a rate dematcher 1002 with a combining buffer. The E-DCH signal is provided to a MAC-e detector 1004 through the rate dematcher 1002 and a decoder 1003.

The MAC-e detector 1004 can determine whether the decoded data is a MAC-e data PDU or a MAC-e control PDU according to the TF information received from the E-DCH controller 1001. For example, if the TF information is TF1, the MAC-e detector 1004 determines that the decoded data is a MAC-e control PDU, and if the TF information indicates any other TF, the MAC-e detector 1004 determines that the decoded data is a MAC-e data PDU. The MAC-e data PDU is provided to a reordering buffer 1006 so as to be transmitted to an upper layer, and the MAC-e PDU is provided to a MAC-e controller 1007 because it has scheduling information.

The MAC-e controller 1007 reads the buffer status and/or power status information from the MAC-e control PDU. A Node B scheduler 1009 allocates uplink data rates to individual UEs based on scheduling information from the UE and other UEs. Although not shown, scheduling assignment information indicating the allocated data rates is transmitted to the UEs on the downlink.

### Fourth Embodiment

A MAC-e data PDU or a MAC-e control PDU is transmitted on one E-DCH. When transmitting the MAC-e control PDU, an E-TFCI indicating the TF of the E-DCH is set to a predetermined value, thereby indicating transmission of the MAC-e control PDU. While the fourth embodiment uses one E-DCH like the third embodiment, it is applicable to an environment where a plurality of E-DCHs are available, one of E-DCHs is transmitted for one TTI, and a transport block size is signaled instead of an E-TFCI.

The third and fourth embodiments of the present invention are similar in that they are implemented by the procedure illustrated in FIG. 8 with the configurations of a UE transmitter and a Node B receiver illustrated in FIGS. 9 and 10. However, the third and fourth embodiments are different in that to notify the Node B of transmission of a MAC-e control PDU on the E-DCH, a predetermined TF is allocated to the MAC-e control PDU in the third embodiment, whereas an E-TFCI preset irrespective of TFS is used as an indicator indicating the MAC-e control PDU transmission in the fourth embodiment.
(E-TFCI)
(0 0 0 0 0)=TF0
(0 0 0 0 1)=TF1
. . .
(1 1 1 1 0)=TF31
(1 1 1 1 1)=MAC-e control PDU indicator

As shown above, E-TFCIs (00000) to (11110) are allocated to packet data among available 5-bit E-TFCIs, and an E-TFCI (11111) is allocated to scheduling information.

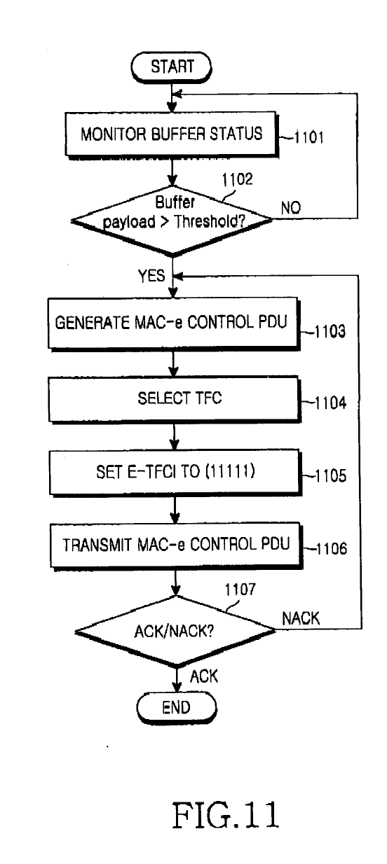

FIG. 11 is a flowchart illustrating a transmission operation in the UE according to a fourth embodiment of the present invention. Referring to FIG. 11, the UE monitors the status of a buffer for storing packet data to be transmitted to the Node B in step 1101 and compares the payload of the buffer with a predetermined threshold in step 1102. If the payload size exceeds the threshold, the UE generates a MAC-e control PDU using the buffer status information and power status information to transmit scheduling information in step 1103. While in the illustrated case, the scheduling information is transmitted when the amount of buffered data is exceeds the threshold, it can be transmitted periodically or upon generation of other predetermined events.

The UE selects a predetermined TFC for the MAC-e control PDU in step 1104. In the absence of packet data to be transmitted for a current TTI, or if packet data exists but has a lower priority level than the scheduling information, the UE selects the predetermined TFC dedicated to transmission of the MAC-e control PDU, for example, TFCI=(11111). The UE sets an E-TFCI to (11111) in step 1105 and transmits the MAC-e control PDU in step 1106. Simultaneously, the UE transmits the E-TFCI on an E-DPCCH.

In step 1107, the UE awaits receipt of an ACK/NACK signal for the MAC-e control PDU from the Node B. If the UE receives the NACK signal or fails to receive the ACK signal, it returns to step 1103 to retransmit the MAC-e control PDU. The reason for returning to step 1103 is to estimate the buffer status and/or the power status without retransmitting the initial MAC-e control PDU at the time retransmission is because the scheduling information may vary over time.

To demodulate the E-DCH, the Node B first detects the E-TFCI from the E-DPCCH signal. If the E-TFCI is (1111), the Node B provides the MAC-e control PDU to the MAC-e controller, determining that the data received on the E-DCH is the MAC-e control PDU. The Node B then can transmit an ACK/NACK signal for the MAC-e control PDU on an ACK/NACK channel to the UE.

In the fourth embodiment of the present invention, the same coding rate and rate matching parameter can be set for both a MAC-e control PDU and a MAC-e data PDU.

In accordance with the present invention as described above, a UE transmits scheduling information of a variable size on an E-DCH supporting HARQ. Because an additional code channel is unnecessary, no PAPR problems are produced and scheduling information transmission is enabled without increasing the complexity of the UE. Also, the reliability of the scheduling information transmission is increased due to the use of a retransmission scheme.

While the present invention has been shown and described with reference to certain preferred embodiments thereof, it will be understood by those skilled in the art that various changes in form and details may be made therein without departing from the spirit and scope of the present invention as defined by the appended claims.

1. A method of transmitting scheduling information for requesting Node B scheduling in a user equipment (UE) in a mobile communication system supporting an enhanced uplink packet data service, comprising the steps of:
generating a MAC-e (Medium Access Control-e) control protocol data unit (PDU) including scheduling information, the scheduling information representing at least one of a buffer status and a power status in relation to uplink data transmission; and
transmitting the MAC-e control PDU on a first enhanced uplink dedicated channel (E-DCH) different from a second E-DCH for transmitting a MAC-e data PDU including uplink packet data.

2. The method of claim 1, wherein the step of transmitting the MAC-e control PDU on the first E-DCH comprises the steps of:
selecting a transport format combination (TFC) that enables simultaneous transmission of the packet data and the scheduling information for a transmission time interval (TTI); and
simultaneously transmitting the packet data and the scheduling information according to the TFC.

3. The method of claim 1, wherein the step of transmitting the MAC-e control PDU on the first E-DCH comprises the steps of:
selecting a transport format combination (TFC) that enables transmission of one of the packet data and the scheduling information for a transmission time interval (TTI); and
transmitting one of the packet data and the scheduling information according to the TFC.

4. The method of claim 3, wherein the step of transmitting the MAC-e control PDU on the first E-DCH further comprises the steps of:
prioritizing the packet data and the scheduling information; and
determining to transmit the scheduling information in the absence of the packet data or if the packet data has a lower priority level than the scheduling information.

5. A method of transmitting scheduling information for requesting Node B scheduling in a user equipment (UE) in a mobile communication system supporting an enhanced uplink packet data service, comprising the steps of:
generating scheduling information representing at least one of a buffer status and a power status in relation to uplink data transmission;
transmitting the scheduling information on an enhanced uplink dedicated channel (E-DCH) for a transmission time interval (TTI); and
transmitting an indicator indicating the transmission of the scheduling information on a control channel other than the E-DCH.

6. The method of claim 5, wherein the indicator is a transport format indicator (TFI) indicating a transport format (TF) preset for transmission of the scheduling information.

7. The method of claim 5, wherein the indicator is a transport format combination indicator (TFCI) indicating a transport format combination (TFC) preset for transmission of the scheduling information.

8. The method of claim 7, wherein the scheduling information is transmitted using a coding rate and rate matching parameter used for the uplink packet data.

9. The method of claim 5, wherein the scheduling information is a MAC-e (Medium Access Control-e) control protocol data unit (PDU) representing at least one of the buffer status and the power status.

10. The method of claim 5, wherein the uplink packet data is a MAC-e (Medium Access Control-e) data protocol data unit (PDU) including uplink data to be transmitted.

11. A method of receiving scheduling information requesting Node B scheduling in a Node B in a mobile communication system supporting an enhanced uplink packet data service, comprising the steps of:
receiving a MAC-e (Medium Access Control-e) protocol data unit (PDU) on an enhanced uplink dedicated channel (E-DCH) and transport format (TF) information of the MAC-e PDU;
determining from the TF information if the MAC-e PDU is scheduling information representing at least one of a buffer status and a power status in relation to uplink data transmission; and
assigning scheduling information representing a data rate for the E-DCH according to the scheduling information.

12. The method of claim 11, wherein the TF information is a transport format indicator (TFI) indicating a TF preset for transmission of the scheduling information.

13. The method of claim 11, wherein the TF information is a transport format combination indicator (TFCI) indicating a transport format combination (TFC) preset for transmitting the scheduling information.

14. An apparatus for transmitting scheduling information to request Node B scheduling in a user equipment (UE) in a mobile communication system supporting an enhanced uplink packet data service, comprising:
a controller for generating scheduling information representing at least one of a buffer status and a power status in relation to uplink data transmission;
a first transmitter for transmitting the scheduling information on an enhanced uplink dedicated channel (E-DCH) for a transmission time interval (TTI) for which uplink packet data is not transmitted; and
a second transmitter for transmitting an indicator indicating the transmission of the scheduling information on a control channel other than the E-DCH.

15. The apparatus of claim 14, wherein the indicator is a transport format indicator (TFI) indicating a transport format (TF) preset for transmission of the scheduling information.

16. The apparatus of claim 14, wherein the indicator is a transport format combination indicator (TFCI) indicating a transport format combination (TFC) preset for transmission of the scheduling information.

17. The apparatus of claim 16, wherein the first transmitter transmits the scheduling information using a same coding rate and rate matching parameter as used for the uplink packet data.

18. The apparatus of claim 14, wherein the scheduling information is a MAC-e (Medium Access Control-e) control protocol data unit (PDU) representing the buffer status and the power status.

19. The apparatus of claim 14, wherein the uplink packet data is a MAC-e (Medium Access Control-e) data protocol data unit (PDU) including uplink data to be transmitted.

20. A apparatus for receiving scheduling information requesting Node B scheduling in a Node B in a mobile communication system supporting an enhanced uplink packet data service, comprising:
a first receiver for receiving a MAC-e (Medium Access Control-e) protocol data unit (PDU) on an enhanced uplink dedicated channel (E-DCH);
a second receiver for receiving information about a transport format (TF) of the MAC-e PDU;
a controller for determining from the TF information if the MAC-e PDU is scheduling information representing at least one of a buffer status and a power status in relation to uplink data transmission; and
a scheduler for uplink data transmission on the E-DCH according to the scheduling information, if the MAC-e PDU is the scheduling information.

21. The apparatus of claim 20, wherein the TF information is a transport format indicator (TFI) indicating a TF preset for transmission of the scheduling information.

22. The apparatus of claim 20, wherein the TF information is a transport format combination indicator (TFCI) indicating a TFC preset for transmission of the scheduling information.

23. A method for data transmission in a mobile communication system, comprising the steps of:
at MAC layer, generating a MAC (Medium Access Control) protocol data unit (PDU) including scheduling information representing at least one of a buffer status and a power status in relation to data transmission;
transmitting the scheduling information on a first physical channel; and
transmitting transport format (TF) information of the MAC PDU on a second physical channel.
